(19) United States
(12) Patent Application Publication
(10) Pub. No.: US 2022/0134571 A1
(43) Pub. Date: May 5, 2022

(54) Display Control Method, Display Program, And Robot System

(71) Applicant: Seiko Epson Corporation, Tokyo (JP)

(72) Inventors: Kaoru TAKEUCHI, Azumino (JP); Hiroki ADACHI, Yokohama (JP); Hirofumi KINOSHITA, Matsumoto (JP)

(21) Appl. No.: 17/514,052

(22) Filed: Oct. 29, 2021

(30) Foreign Application Priority Data
Oct. 30, 2020 (JP) 2020-183020

(51) Int. Cl. B25J 9/16; B25J 18/04

(52) U.S. Cl. CPC B25J 9/1697; B25J 18/04; B25J 9/1602

(57) ABSTRACT

There is provided a display control method for controlling a display section configured to display a display image including a virtual robot, which is a simulation model of a robot including a robot arm that performs work according to force control, the display control method including a receiving step for receiving information concerning force control parameters including first information concerning a target force, which is a target of force received by the robot arm during the work, and a display step for displaying, in the display image, the virtual robot, a first indicator indicating the first information, and a second indicator indicating second information concerning force applied to the robot arm during the work, the virtual robot, the first indicator, and the second indicator temporally overlapping one another and being distinguished from one another.

The present application is based on, and claims priority from JP Application Serial Number 2020-183020, filed Oct. 30, 2020, the disclosure of which is hereby incorporated by reference herein in its entirety.

### BACKGROUND

### 1. Technical Field

The present disclosure relates to a display control method, a display program, and a robot system.

### 2. Related Art

For example, as disclosed in JP-A-2017-1122 (Patent Literature 1), there has been known a robot including a robot arm and a force detecting section that detects force applied to the robot arm, the robot performing predetermined work by performing force control for driving the robot arm based on a detection result of the force detecting section. Before the robot performs work, an operator sets force control parameters such as a target force of force received by the robot arm during the work. Consequently, the operator can cause the robot to perform desired work.

In Patent Literature 1, by displaying which degree of force is applied to a workpiece and a place where the force is applied during work, the operator can visually grasp work content. Consequently, the operator can recognize whether the work is appropriate.

However, even if the operator simply grasps which degree of force is applied to the workpiece during the work, it is difficult to determine whether the magnitude of the force is appropriate.

### SUMMARY

A display control method according to an aspect of the present disclosure is a display control method for controlling a display section configured to display a display image including a virtual robot, which is a simulation model of a robot including a robot arm that performs work according to force control, the display control method including: a receiving step for receiving information concerning force control parameters including first information concerning a target force, which is a target of force received by the robot arm during the work; and a display step for displaying, in the display image, the virtual robot, a first indicator indicating the first information, and a second indicator indicating second information concerning force applied to the robot arm during the work, the virtual robot, the first indicator, and the second indicator temporally overlapping one another and being distinguished from one another.

A non-transitory computer-readable storage medium according to an aspect of the present disclosure stores a display program for executing a display control method for controlling a display section configured to display a display image including a virtual robot, which is a simulation model of a robot including a robot arm that performs work according to force control, the program causing a computer to execute: a receiving step for receiving information concerning force control parameters including first information concerning a target force, which is a target of force received by the robot arm during the work; and a display step for displaying, in the display image, the virtual robot, a first indicator indicating the first information, and a second indicator indicating second information concerning force applied to the robot arm during the work, the virtual robot, the first indicator, and the second indicator temporally overlapping one another and being distinguished from one another.

A robot system according to an aspect of the present disclosure includes: a robot including a robot arm that performs work according to force control; a display section configured to display a display image including a virtual robot, which is a simulation model of the robot; and a control section configured to control the display section. The control section receives information concerning force control parameters including first information concerning a target force, which is a target of force received by the robot arm during the work and displays, in the display image, the virtual robot, a first indicator indicating the first information, and a second indicator indicating second information concerning force applied to the robot arm during the work, the virtual robot, the first indicator, and the second indicator temporally overlapping one another and being distinguished from one another.

### BRIEF DESCRIPTION OF THE DRAWINGS

FIG. 1 is a diagram showing an overall configuration of a robot system according to the present disclosure.

FIG. 2 is a block diagram of the robot system shown in FIG. 1.

FIG. 3 is a diagram showing an example of a display image displayed in a display step.

FIG. 4 is a diagram showing an example of a display image displayed in the display step.

FIG. 5 is a diagram showing an example of the display image displayed in the display step.

FIG. 6 is a diagram showing an example of the display image displayed in the display step.

FIG. 7 is a diagram showing an example of the display image displayed in the display step.

FIG. 8 is a diagram showing an example of the display image displayed in the display step.

FIG. 9 is a diagram for explaining variations of a change of a first indicator or a second indicator displayed in the display step.

FIG. 10 is a diagram showing an example of the display image displayed in the display step.

FIG. 11 is a diagram showing an example of the display image displayed in the display step.

FIG. 12 is a flowchart for explaining a display control method according to the present disclosure.

FIG. 13 is a block diagram for explaining a robot system centering on hardware.

FIG. 14 is a block diagram showing a modification 1 centering on the hardware of the robot system.

FIG. 15 is a block diagram showing a modification 2 centering on the hardware of the robot system.

### DESCRIPTION OF EXEMPLARY EMBODIMENTS

### Embodiment

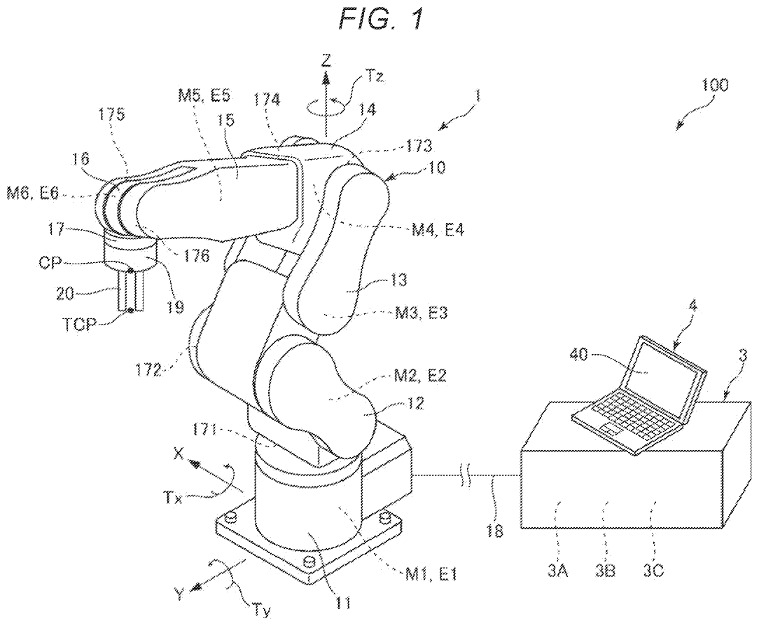

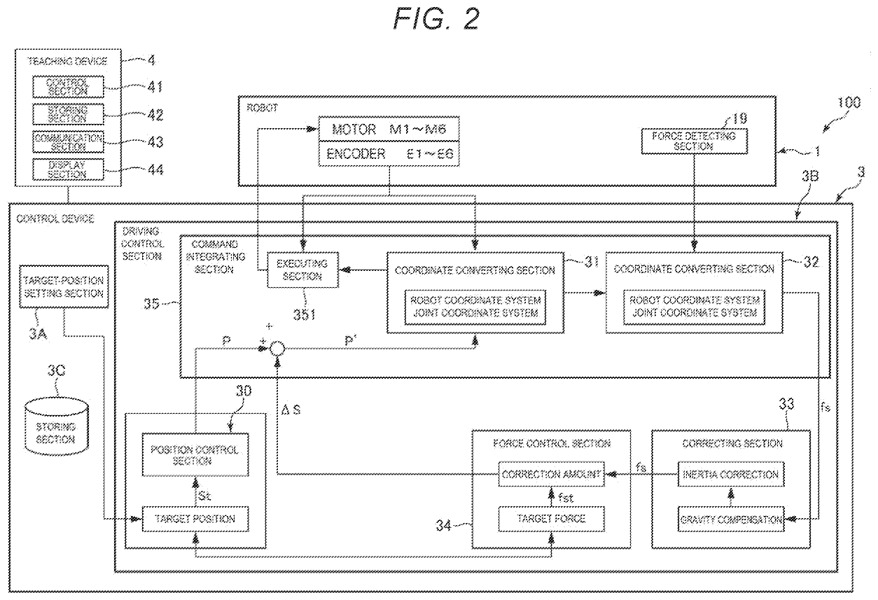

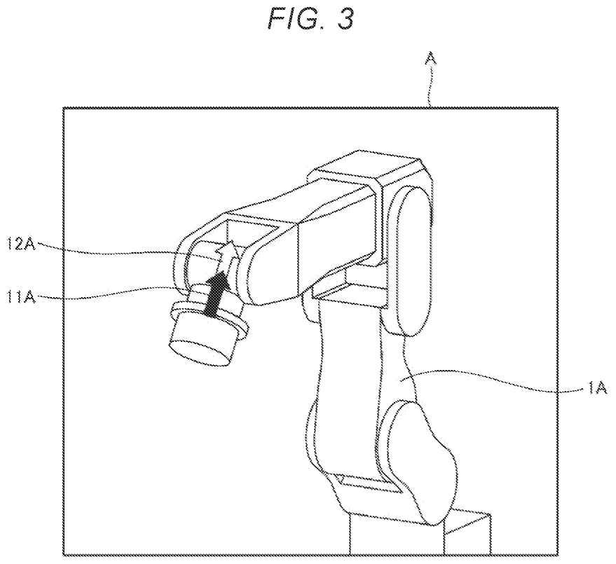

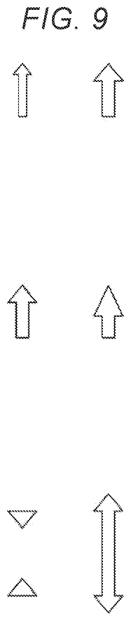

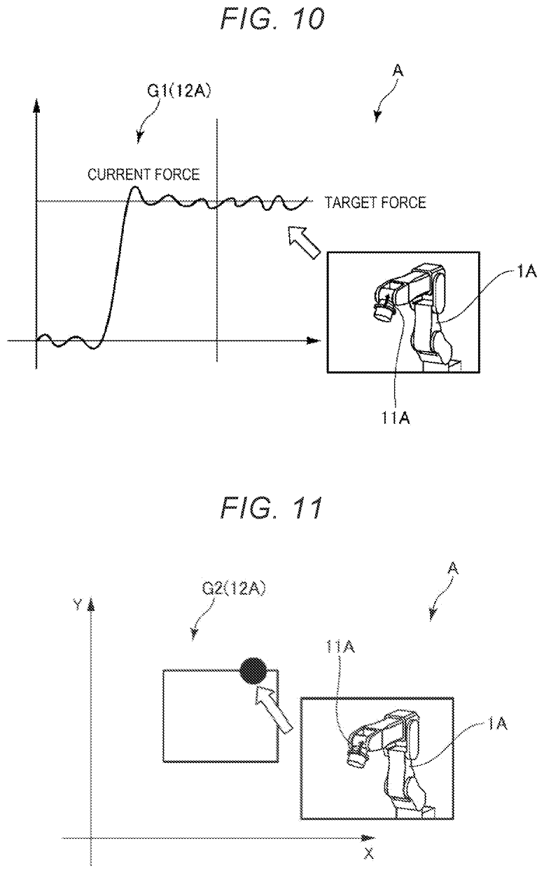

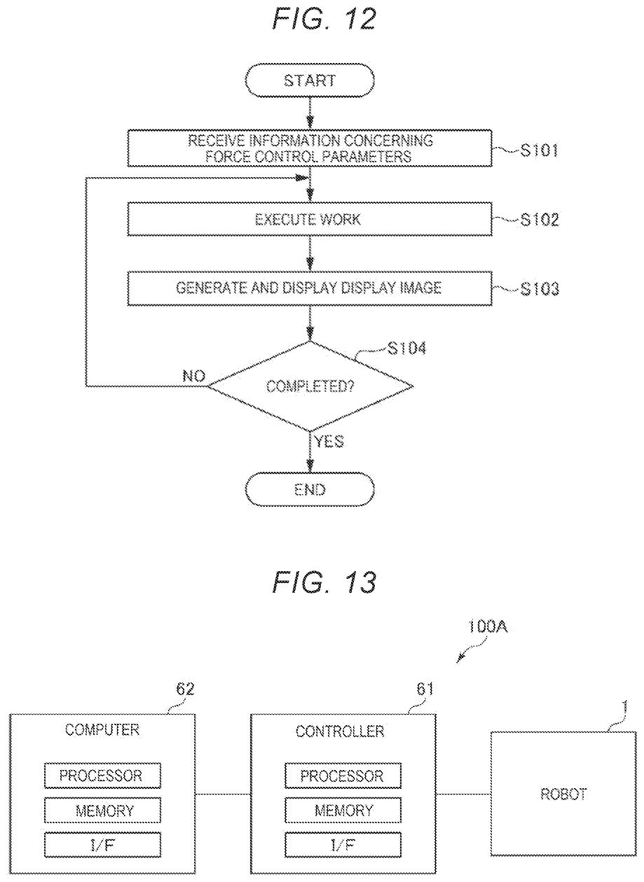

FIG. 1 is a diagram showing an overall configuration of a robot system according to the present disclosure. FIG. 2 is a block diagram of the robot system shown in FIG. 1. FIGS. 3 to 8 are diagrams showing examples of a display image displayed in a display step. FIG. 9 is a diagram for explaining variations of a change of a first indicator or a second indicator displayed in the display step. FIGS. 10 and 11 are diagrams showing examples of the display image displayed in the display step. FIG. 12 is a flowchart for explaining a display control method according to the present disclosure.

A display control method, a display program, and a robot system are explained in detail below with reference to a preferred embodiment shown in the accompanying drawings. In the following explanation, for convenience of explanation, a +Z-axis direction, that is, an upper side in FIG. 1 is referred to as “upper” as well and a −Z-axis direction, that is, a lower side in FIG. 1 is referred to as “lower” as well. About a robot arm, a base 11 side in FIG. 1 is referred to as “proximal end” as well and the opposite side of the base 11 side, that is, an end effector side in FIG. 1 is referred to as “distal end” as well. A Z-axis direction, that is, an up-down direction in FIG. 1 is represented as a “vertical direction” and an X-axis direction and a Y-axis direction, that is, a left-right direction in FIG. 1 is represented as a “horizontal direction”.

As shown in FIG. 1, a robot system 100 includes a robot 1, a control device 3 that controls the robot 1, and a teaching device 4.

First, the robot 1 is explained.

The robot 1 shown in FIG. 1 is a single-arm six-axis vertical articulated robot in this embodiment and includes a base 11 and a robot arm 10. An end effector 20 can be attached to the distal end portion of the robot arm 10. The end effector 20 may be a constituent element of the robot 1 or may not be a constituent element of the robot 1.

The robot 1 is not limited to the configuration shown in FIG. 1 and may be, for example, a double-arm articulated robot. The robot 1 may be a horizontal articulated robot.

The base 11 is a supporting body that supports the robot arm 10 from the lower side to be capable of driving the robot arm 10. The base 11 is fixed to, for example, a floor in a factory. In the robot 1, the base 11 is electrically coupled to the control device 3 via a relay cable 18. The coupling of the robot 1 and the control device 3 is not limited to the coupling by wire in the configuration shown in FIG. 1 and may be, for example, coupling by radio. Further, the robot 1 and the control device 3 may be coupled via a network such as the Internet.

In this embodiment, the robot arm 10 includes a first arm 12, a second arm 13, a third arm 14, a fourth arm 15, a fifth arm 16, and a sixth arm 17. These arms are coupled in this order from the base 11 side. The number of arms included in the robot arm 10 is not limited to six and may be, for example, one, two, three, four, five, or seven or more. The sizes such as total lengths of the arms each are not particularly limited and can be set as appropriate.

The base 11 and the first arm 12 are coupled via a joint 171. The first arm 12 has a first turning axis parallel to the vertical direction as a turning center and is capable of turning with respect to the base 11 around the first turning axis. The first turning axis coincides with the normal of the floor to which the base 11 is fixed.

The first arm 12 and the second arm 13 are coupled via a joint 172. The second arm 13 is capable of turning with respect to the first arm 12 with a second turning axis parallel to the horizontal direction set as a turning center. The second turning axis is parallel to an axis orthogonal to the first turning axis.

The second arm 13 and the third arm 14 are coupled via a joint 173. The third arm 14 is capable of turning with respect to the second arm 13 with a third turning axis parallel to the horizontal direction set as a turning center. The third turning axis is parallel to the second turning axis.

The third arm 14 and the fourth arm 15 are coupled via a joint 174. The fourth arm 15 is capable of turning with respect to the third arm 14 with a fourth turning axis parallel to a center axis direction of the third arm 14 set as a turning center. The fourth turning axis is orthogonal to the third turning axis.

The fourth arm 15 and the fifth arm 16 are coupled via a joint 175. The fifth arm 16 is capable of turning with respect to the fourth arm 15 with a fifth turning axis set as a turning center. The fifth turning axis is orthogonal to the fourth turning axis.

The fifth arm 16 and the sixth arm 17 are coupled via a joint 176. The sixth arm 17 is capable of turning with respect to the fifth arm 16 with a sixth turning axis set as a turning center. The sixth turning axis is orthogonal to the fifth turning axis.

The sixth arm 17 is a robot distal end portion located on the most distal end side in the robot arm 10. The sixth arm 17 can turn together with the end effector 20 according to driving of the robot arm 10.

The robot 1 includes a motor M1, a motor M2, a motor M3, a motor M4, a motor M5, and a motor M6 functioning as driving sections and an encoder E1, an encoder E2, an encoder E3, an encoder E4, an encoder E5, and an encoder E6. The motor M1 is incorporated in the joint 171 and relatively rotates the base 11 and the first arm 12. The motor M2 is incorporated in the joint 172 and relatively rotates the first arm 12 and the second arm 13. The motor M3 is incorporated in the joint 173 and relatively rotates the second arm 13 and the third arm 14. The motor M4 is incorporated in the joint 174 and relatively rotates the third arm 14 and the fourth arm 15. The motor M5 is incorporated in the joint 175 and relatively rotates the fourth arm 15 and the fifth arm 16. The motor M6 is incorporated in the joint 176 and relatively rotates the fifth arm 16 and the sixth arm 17.

The encoder E1 is incorporated in the joint 171 and detects the position of the motor M1. The encoder E2 is incorporated in the joint 172 and detects the position of the motor M2. The encoder E3 is incorporated in the joint 173 and detects the position of the motor M3. The encoder E4 is incorporated in the joint 174 and detects the position of the motor M4. The encoder E5 is incorporated in the joint 175 and detects the position of the motor M5. The encoder E6 is incorporate in the joint 176 and detects the position of the motor M6.

The encoders E1 to E6 are electrically coupled to the control device 3. Position information, that is, rotation amounts of the motors M1 to M6 are transmitted to the control device 3 as electric signals. The control device 3 drives the motors M1 to M6 via a not-shown motor driver based on the information. That is, controlling the robot arm 10 means controlling the motors M1 to M6.

A control point CP is set at the distal end of the robot arm 10. The control point CP means a point serving as a reference in performing control of the robot arm 10. The robot system 100 grasps the position of the control point CP in a robot coordinate system and drives the robot arm 10 such that the control point CP moves to a desired position.

In the robot 1, a force detecting section 19 that detects force is detachably set in the robot arm 10. The robot arm 10 can be driven in a state in which the force detecting section 19 is set in the robot arm 10. In this embodiment, the force detecting section 19 is a six-axis force sensor. The force detecting section 19 detects the magnitudes of forces on three detection axes orthogonal to one another and the magnitudes of torques around the three detection axes. That is, the force detecting section 19 detects force components in axial directions of an X axis, a Y axis, and a Z axis orthogonal to one another, a force component in a Tx direction, which is a direction around the X axis, a force component in a Ty direction, which is a direction around the Y axis, and a force component in a Tz direction, which is a direction around the Z axis. In this embodiment, the Z-axis direction is the vertical direction. The force components in the axial directions can be referred to as “translational force components” as well and the force components around the axes can be referred to as “rotational force components” as well. The force detecting section 19 is not limited to the six-axis force sensor and may be a sensor having another configuration.

In this embodiment, the force detecting section 19 is set in the sixth arm 17. A setting place of the force detecting section 19 is not limited to the sixth arm 17, that is, the arm located on the most distal end side. The force detecting section 19 may be set in another arm or between the arms adjacent to each other or may be set below the base 11. A plurality of force detecting sections 19 may be respectively set in all the joints.

The end effector 20 can be detachably attached to the force detecting section 19. The end effector 20 is configured by a hand, a pair of claws of which approaches and separates to thereby grip and release an object. However, in the present disclosure, the end effector 20 is not limited to this and may include two or more claws. The end effector 20 may be a hand that grips an object with attraction.

In the robot coordinate system, a tool center point TCP is set in any position at the distal end of the end effector 20, preferably, at the distal end in a state in which the claws approach. As explained above, the robot system 100 grasps the position of the control point CP in the robot coordinate system and drives the robot arm 10 such that the control point CP moves to a desired position. A distal end coordinate system having the control point CP as the origin is set at the distal end of the robot arm 10.

By grasping a type, in particular, the length of the end effector 20, it is possible to grasp an offset amount between the tool center point TCP and the control point CP. Accordingly, the position of the tool center point TCP can be grasped in the robot coordinate system. Therefore, the tool center point TCP can be set as a reference of control.

The control device 3 is explained.

The control device 3 is disposed to be separated from the robot 1 and can be configured by a computer or the like incorporating a CPU (Central Processing Unit), which is an example of a processor. The control device 3 may be incorporated in the base 11 of the robot 1.

The control device 3 is communicably coupled to the robot 1 by the relay cable 18. The control device 3 is wirelessly communicably coupled to the teaching device 4 by a cable. The teaching device 4 may be a dedicated computer or may be a general-purpose computer installed with a program for teaching the robot 1. For example, a teaching pendant or the like, which is a dedicated device for teaching the robot 1, may be used instead of the teaching device 4. Further, the control device 3 and the teaching device 4 may include separate housings or may be integrally configured.

The teaching device 4 may be installed with a program for generating an execution program having a target position and posture Sₜ and a target force f_{St} explained below as arguments and loading the execution program to the control device 3. The teaching device 4 includes a display, a processor, a RAM, and a ROM. These hardware resources cooperate with a teaching program to generate the execution program.

As shown in FIG. 2, the control device 3 is a computer installed with a control program for performing control of the robot 1. The control device 3 includes a processor and a RAM and a ROM not shown in FIG. 3. These hardware resources cooperate with a program to thereby control the robot 1.

As shown in FIG. 2, the control device 3 includes a target-position setting section 3A, a driving control section 3B, and a storing section 3C. The storing section 3C is configured by, for example, a volatile memory such as a RAM (Random Access Memory), a nonvolatile memory such as a ROM (Read Only Memory), and a detachable external storage device. An operation program or the like for causing the robot 1 to operate is stored in the storing section 3C.

The target-position setting section 3A sets the target position and posture Sₜ and an operation route for executing predetermined work on a workpiece W1. The target-position setting section 3A sets the target position and posture Sₜ and the operation route based on teaching information and the like input from the teaching device 4.

The driving control section 3B controls driving of the robot arm 10 and includes a position control section 30, a coordinate converting section 31, a coordinate converting section 32, a correcting section 33, a force control section 34, and a command integrating section 35.

The position control section 30 generates, according to a target position designated by a command created in advance, a position command signal, that is, a position command value for controlling the position of the tool center point TCP of the robot 1.

The control device 3 is capable of controlling the operation of the robot 1 with force control or the like. The “force control” means control of the operation of the robot 1 for changing, based on a detection result of the force detecting section 19, the position of the end effector 20, that is, the position of the tool center point TCP and the postures of the first to sixth arms 12 to 17.

The force control includes, for example, force trigger control and impedance control. In the force trigger control, the control device 3 performs force detection with the force detecting section 19. The control device 3 causes the robot arm 10 to perform operations of movement and a change in a posture until predetermined force is detected by the force detecting section 19.

The impedance control includes tracer control. In the impedance control, the control device 3 controls the operation of the robot arm 10 to maintain force applied to the distal end portion of the robot arm 10 at predetermined force as much as possible, that is, maintain a force in a predetermined direction detected by the force detecting section 19 at the target force f_{St} as much as possible. Consequently, for example, when the impedance control is performed on the robot arm 10, the robot arm 10 performs an operation for tracing, in the predetermined direction, a target object or an external force applied from an operator. The target force f_{St} includes 0 as well. For example, as one kind of setting in the case of the tracing operation, a target value can be set to “0”. The target force f_{St} can be set to a numerical value other than 0. The operator can set the target force f_{St} as appropriate via, for example, the teaching device 4. The target force f_{St} can also be set for each of the directions of the axes (X, Y, and Z) or each of the directions around the axes (Tx, Ty and Tz).

The storing section 3C stores a correspondence relation between a combination of rotation angles of the motors M1 to M6 and the position of the tool center point TCP in the robot coordinate system. The control device 3 stores, in the storing section 3C, based on a command, at least one of the target position and posture Sₜ and the target force f_{St} for each of processes of work performed by the robot 1. A command having the target position and posture Sₜ and the target force f_{St} as arguments, that is, parameters is set for each of the processes of the work performed by the robot 1.

The driving control section 3B controls the first to sixth arms 12 to 17 such that the set target position and posture Sₜ and the set target force f_{St} coincide at the tool center point TCP. The target force f_{St} is a detected force and detected torque of the force detecting section 19 that should be achieved by the operations of the first to sixth arms 12 to 17. The character “S” represents any one direction of the directions of the axes (X, Y, and Z) defining the robot coordinate system. S also represents a position in an S direction. For example, when S=X, an X-direction component of a target position set in the robot coordinate system is Sₜ=Xₜ and an X-direction component of a target force is f_{St}=f_{Xt}.

In the driving control section 3B, when rotation angles of the motors M1 to M6 are acquired, the coordinate converting section 31 shown in FIG. 2 converts, based on the correspondence relation, the rotation angles into a position and posture S of the tool center point TCP in the robot coordinate system. The coordinate converting section 32 specifies, based on the position and posture S of the tool center point TCP and a detection value of the force detecting section 19, in the robot coordinate system, an acting force f_{S} actually acting on the force detecting section 19.

An acting point of the acting force f_{S} is defined as a force detection origin separately from the tool center point TCP. The force detection origin corresponds to a point where the force detecting section 19 is detecting force. The control device 3 stores, for each of positions and postures S of the tool center point TCP in the robot coordinate system, a correspondence relation specifying directions of detection axes in a sensor coordinate system of the force detecting section 19. Therefore, the control device 3 can specify the acting force f_{S} in the robot coordinate system based on the position and posture S of the tool center point TCP in the robot coordinate system and the correspondence relation. Torque acting on the robot 1 can be calculated from the acting force f_{S} and the distance from a contact point to the force detecting section 19 and is specified as a rotational force component. When the end effector 20 comes into contact with the workpiece W1 and performs work, the contact point can be regarded as the tool center point TCP.

The correcting section 33 performs gravity compensation on the acting force f_{S}. The gravity compensation means removing components of force and torque due to the gravity from the acting force f_{S}. The acting force f_{S} subjected to the gravity compensation can be regarded as force other than the gravity acting on the robot arm 10 or the end effector 20.

The correcting section 33 performs inertia compensation on the acting force f_{S}. The inertia compensation means removing components of force and torque due to an inertial force from the acting force f_{S}. The acting force f_{S} subjected to the inertia compensation can be regarded as force other than the inertial force acting on the robot arm 10 or the end effector 20.

The force control section 34 performs impedance control. The impedance control is active impedance control for realizing virtual mechanical impedance with the motors M1 to M6. The control device 3 executes such impedance control when performing processes in a contact state in which the end effector 20 receives force from a target object such as fitting work, screwing work, and polishing work and direct teaching. In processes other than such processes, safety can be improved by performing, for example, the impedance control when a human touches the robot 1.

In the impedance control, the force control section 34 substitutes the target force f_{St} in an equation of motion explained blow to derive rotation angles of the motors M1 to M6. A signal with which the control device 3 controls the motors M1 to M6 is a PWM (Pulse Width Modulation)-modulated signal.

In a process in a noncontact state in which the end effector 20 does not receive an external force, the control device 3 controls the motors M1 to M6 with rotation angles derived from the target position and posture Sₜ by a linear operation. A mode for controlling the motors M1 to M6 at the rotation angles derived from the target position and posture Sₜ by the linear operation is referred to as a position control mode.

The control device 3 specifies a force-derived correction amount ΔS by substituting the target force f_{St} and the acting force f_{S} in an equation of motion of the impedance control. The force-derived correction amount ΔS means the magnitude of the position and posture S to which the tool center point TCP should move in order to cancel a force deviation Δf_{S}(t) from the target force f_{St} when the tool center point TCP receives mechanical impedance. Expression (1) described below is the equation of motion of the impedance control.

mΔ\ddot{S}(t)+dΔ\dot{S}(t)+kΔS(t)=Δf_{S}(t) (1)

The left side of Expression (1) is formed by a first term obtained by multiplying a second order differential value of the position and posture S of the tool center point TCP by a virtual mass coefficient m (hereinafter referred to as “mass coefficient m”), a second term obtained by multiplying a differential value of the position and posture S of the tool center point TCP by a virtual coefficient of viscosity d (hereinafter referred to as “coefficient of viscosity d”), and a third term obtained by multiplying the position and posture S of the tool center point TCP by a virtual modulus of elasticity k (hereinafter referred to as “modulus of elasticity k”). The right side of Expression (1) is formed by a force deviation Δf_{S}(t) obtained by subtracting actual force f from the target force f_{St}. Differential in Expression (1) means differential by time. In a process performed by the robot 1, in some case, a fixed value is set as the target force f_{St} or a function of time is set as the target force f_{St}.

The mass coefficient m means mass that the tool center point TCP virtually has. The coefficient of viscosity d means viscosity resistance that the tool center point TCP virtually receives. The modulus of elasticity k means a spring constant of an elastic force that the tool center point TCP virtually receives.

As a value of the mass coefficient m increases, the acceleration of a motion decreases. As the value of the mass coefficient m decreases, the acceleration of the motion increases. As a value of the coefficient of viscosity d increases, the speed of the motion decreases. As the value of the coefficient of viscosity d decreases, the speed of the operation increases. As a value of the modulus of elasticity k increases, a spring property increases. As the value of the modulus of elasticity k decreases, the spring property decreases.

The mass coefficient m, the coefficient of viscosity d, and the modulus of elasticity k may be set to different values for each of directions or may be set to common values irrespective of directions. The operator can set the mass coefficient m, the coefficient of viscosity d, and the modulus of elasticity k as appropriate before work. The operator inputs the mass coefficient m, the coefficient of viscosity d, and the modulus of elasticity k using, for example, the teaching device 4.

The mass coefficient m, the coefficient of viscosity d, and the modulus of elasticity k are force control parameters. The force control parameters are values set before the robot arm 10 actually performs work. The force control parameters include the target force f_{St} besides the mass coefficient m, the coefficient of viscosity d, and the modulus of elasticity k.

In this way, the robot system 100 calculates, during execution of force control, a correction amount from a detection value of the force detecting section 19, preset force control parameters, and a preset target force. The correction amount means the force-derived correction amount AS explained above and means a difference from a position to which the tool center point TCP should be move from a position where an external force is received.

The command integrating section 35 adds the force-derived correction amount ΔS to the position command value P generated by the position control section 30. By performing the addition at any time, the command integrating section 35 calculates a new position command value P′ from the position command value P used to move the tool center point TCP to the position where the external force is received.

The coordinate converting section 31 converts the new position command value P′ into a robot coordinate and an executing section 351 executes the new position command value P′. Consequently, it is possible to move the tool center point TCP to a position obtained by taking into account the force-derived correction amount ΔS, respond to the external force, and prevent a more load from being applied to a target object that comes into contact with the robot 1.

With such a driving control section 3B, in a state in which the robot arm 10 grips the target object, it is possible to drive the robot arm 10 such that the tool center point TCP moves until the target force f_{St} reaches a preset value while moving the tool center point TCP toward the target position and posture Sₜ. Consequently, assembly work such as fitting work can be executed by force control. It is possible to prevent a load from being excessively applied to the target object during work.

The teaching device 4 is explained.

As shown in FIG. 2, the teaching device 4 is a device that receives various settings, generates an operation program, and generates and displays a display image A shown in FIGS. 3 to 8, 10, and 11. The teaching device 4 includes a control section 41, a storing section 42, a communication section 43, and a display section 40. In the configuration shown in FIG. 1, the teaching device 4 is a notebook personal computer. However, in the present disclosure, the teaching device 4 is not limited to this and may be, for example, a desktop personal computer, a tablet terminal, or a smartphone.

The control section 41 includes at least one processor. Examples of the processor include a CPU (Central Processing Unit) and a GPU (Graphics Processing Unit). The control section 41 reads out and executes various programs and the like stored in the storing section 42. Examples of the various programs include an operation program for the robot arm 10 and a display program according to the present disclosure explained below. The programs may be generated by the teaching device 4, may be stored from an external recording medium such as a CD-ROM, or may be stored via a network or the like.

A signal generated by the control section 41 is transmitted to the control device 3 of the robot 1 via the communication section 43. Consequently, the robot arm 10 can execute predetermined work under predetermined conditions. As shown in FIGS. 3 to 9, the control section 41 controls driving of the display section 40. That is, the control section 41 functions as a display control section that controls the operation of the display section 40.

The control section 41 generates the display image A explained below and controls the operation of the display section 40 to display the display image A on the display section 40.

The storing section 42 saves various programs executable by the control section 41, various kinds of setting information, and the like. Examples of the storing section 42 include a volatile memory such as a RAM (Random Access Memory), a nonvolatile memory such as a ROM (Random Access Memory), and a detachable external storage device.

The communication section 43 performs transmission and reception of signals to and from the control device 3 using an external interface such as a wired LAN (Local Area Network) or a wireless LAN.

The display section 40 is configured by various displays including a display screen. In this embodiment, the operator can input various settings by operating an input operation section such as a mouse or a keyboard. However, the display section 40 is not limited to this configuration and may be, for example, a touch panel, that is, the display section 40 may include a display function and an input operation function. The touch panel and the mouse and the keyboard may be concurrently used.

The display section 40 is not limited to the configuration shown in FIG. 2 and may be configured to form an image on a target object or in the air.

Examples of the various settings set by the operator include the mass coefficient m, the coefficient of viscosity d, the modulus of elasticity k, and the target force f_{St}. That is, the operator sets force control parameters using the teaching device 4.

The display image A that the control section 41 generates and causes the display section 40 to display is explained. The display image A may be a moving image that changes following the operation of the robot 1 in real time or may be a moving image that reproduces the operation after work of the robot 1 ends. In the following explanation, the display image A is explained as the moving image that changes following the operation of the robot 1 in real time.

As shown in FIGS. 3 to 8, 10, and 11, the display image A includes a virtual robot 1A, a first indicator 11A, and a second indicator 12A. The virtual robot 1A, the first indicator 11A, and the second indicator 12A are displayed to temporally overlap one another and to be distinguished from one another.

The virtual robot 1A is a simulation model of the robot 1. The shape of the virtual robot 1A corresponds to the shape of the robot 1. The virtual robot 1A may be 3DCG generated based on the robot 1 or may be an image obtained by imaging the robot 1.

The first indicator 11A indicates first information concerning the target force f_{St}, which is a target of force received by the robot arm 10 during work. In this embodiment, the first indicator 11A is formed by an arrow, indicates a direction of the set target force f_{St} with a direction pointed by the arrow, and indicates the magnitude of the target force f_{St} with the shape of the arrow.

The second indicator 12A indicates second information concerning the acting force f_{S}, that is, the force applied to the robot arm 10 during the work. In this embodiment, the second indicator 12A is formed by an arrow and indicates, with a direction pointed by the arrow, a direction in which the force is applied and indicates, with the shape of the arrow, the magnitude of the force. The shape of the second indicator 12A changes in real time according to the magnitude of the force applied to the robot arm 10 during the work.

In the display image A, the virtual robot 1A, the first indicator 11A, and the second indicator 12A are displayed to temporally overlap one another and to be distinguished from one another. “Displayed to temporally overlap” means that the first indicator 11A and the second indicator 12A at the same predetermined time are displayed. “Displayed to be distinguished” means that the first indicator 11A and the second indicator 12A are displayed in at least one of colors, sizes, shapes, lengths, thicknesses, and sharpness degrees different from each other or respectively displayed in different positions. Accordingly, the operator can compare the first indicator 11A and the second indicator 12A and easily recognize, at a glance, which degree of force is actually applied to the robot arm 10 with respect to the set target force f_{St}, that is, whether the force is within a normal range. Accordingly, for example, when the set target force f_{St} is inappropriate, the operator can set a desired target force f_{St} at the next and subsequent setting times. When determining that the force applied to the robot arm 10 is inappropriate, the operator can set, for example, the mass coefficient m, the coefficient of viscosity d, and the modulus of elasticity k to appropriate values at the next and subsequent setting times. In this way, according to the present disclosure, the operator can compare the target force f_{St} and the force applied to the robot arm 10 in a work result and easily determine whether setting of force control parameters is proper. Accordingly, the operator can feedback the quality of the last setting and set appropriate force control parameters at the next and subsequent setting times.

The control section 41 acquires operation information of the robot 1 during work from the control device 3 and generates the display image A in which the virtual robot 1A performs the same operation as the operation of the robot 1. Consequently, the operator can grasp a movement of the robot 1 and can grasp which degree of force is applied to the robot 1 when the robot 1 is in what kind of a posture.

Variations of the display image A are explained below.

In a configuration shown in FIG. 3, the first indicator 11A and the second indicator 12A are displayed to overlap each other at the distal end portion of a robot arm of the virtual robot 1A. That is, the first indicator 11A and the second indicator 12A are displayed in the same position. The first indicator 11A and the second indicator 12A face the same direction.

In the configuration shown in FIG. 3, the first indicator 11A and the second indicator 12A have colors different from each other. Consequently, the operator can grasp, at a glance, which of the arrows corresponds to which of the first indicator 11A and the second indicator 12A.

In the configuration shown in FIG. 3, the length of the second indicator 12A changes in real time.

With such a configuration, the operator can compare the length of the first indicator 11A and the length of the second indicator 12A and grasp, at a glance, which of the first indicator 11A and the second indicator 12A is larger. Accordingly, the operator can more surely set appropriate force control parameters at the next and subsequent setting times.

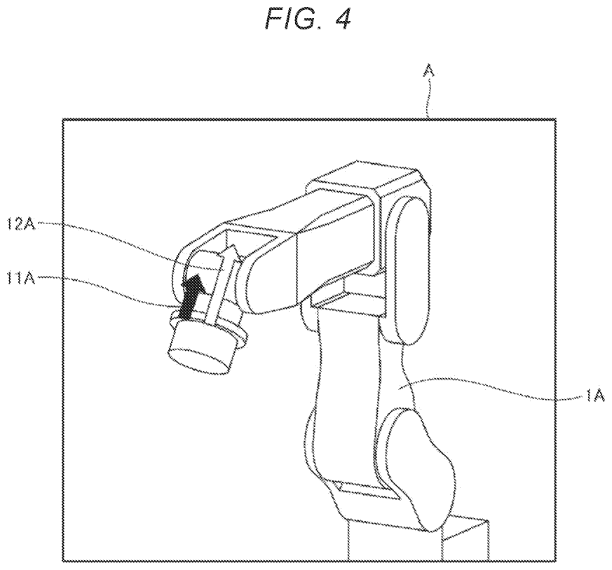

A configuration shown in FIG. 4 is explained. In the following explanation, only matters different from the matters in the configuration shown in FIG. 3 are explained. In the configuration shown in FIG. 4, the first indicator 11A and the second indicator 12A are disposed in positions different from each other. Specifically, the first indicator 11A and the second indicator 12A are disposed side by side at the distal end portion of the robot arm of the virtual robot 1A.

With such a configuration, it is possible to prevent one of the first indicator 11A and the second indicator 12A from being hidden and less easily seen irrespective of the lengths of the first indicator 11A and the second indicator 12A. Accordingly, the operator can more surely set appropriate force control parameters at the next and subsequent setting times.

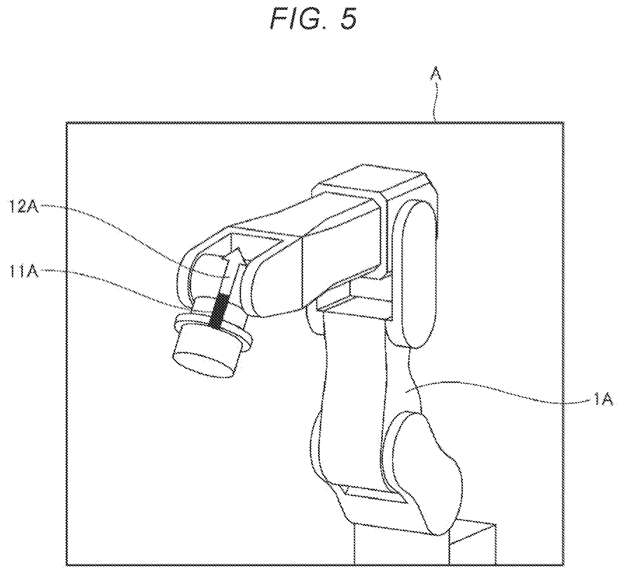

A configuration shown in FIG. 5 is explained. In the following explanation, only matters different from the matters in the configuration shown in FIG. 3 and the configuration shown in FIG. 4 are explained. In the configuration shown in FIG. 5, the first indicator 11A and the second indicator 12A are displayed as one arrow. The arrow is displayed in two colors, that is, a color indicating the first indicator 11A and a color indicating the second indicator 12A. A ratio of the color indicating the second indicator 12A in the arrow changes according to force received by the robot arm 10 during work.

With such a configuration, the operator can grasp, at a glance, which of the first indicator 11A and the second indicator 12A is larger. Accordingly, the operator can more surely set appropriate force control parameters at the next and subsequent setting times. Further, in the configuration shown in FIG. 5, since only one arrow is displayed, it is possible to further reduce a portion of the robot arm of the virtual robot 1A hidden by the arrow. Accordingly, the operator can more accurately grasp a movement of the virtual robot 1A.

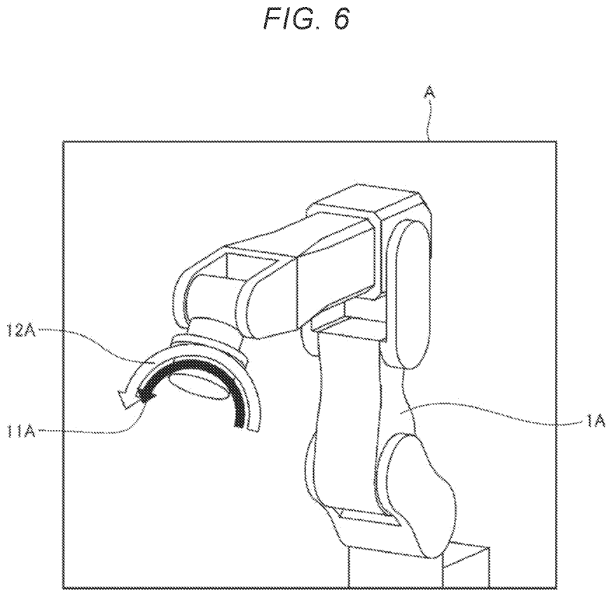

As explained above, the target force f_{St} can be set for each of the directions of axes (X, Y, and Z) and for each of the directions around the axes (Tx, Ty, and Tz). In this case, the target force f_{St} can also be displayed for each of these components. For example, when the torque Tz around the Z axis in the distal end coordinate system in the target force f_{St} is displayed as shown in FIG. 6, the torque Tz can be displayed as a semi-arcuate arrow as shown in FIG. 6. In the case of this configuration, the semi-arcuate arrow is the first indicator 11A. A direction pointed by the arrow indicates a direction of torque.

Force applied around the Y axis in the distal end coordinate system, that is, the torque Ty is displayed as an arrow near the first indicator 11A. The arrow is the second indicator 12A. In the configuration shown in FIG. 6, colors of two arrows are different. The length or the thickness of the second indicator 12A changes according to the magnitude of the torque Tz.

In FIG. 6, the torque Tz is explained as an example. However, in the present disclosure, display of torque is not limited to this. The torque Tx and the torque Ty may be displayed, all of the torque Tx, the torque Ty, and the torque Tz may be displayed, a direction in which any one of the torque Tx, the torque Ty, and the torque Tz is displayed may be selectable, or the torque Tx, the torque Ty, and the torque Tz may be able to be switched halfway in the display. A direction in which any two of the torque Tx, the torque Ty, and the torque Tz is displayed may be selectable. Further, a combined torque obtained by combining the torque Tx, the torque Ty, and the torque Tz may be displayed.

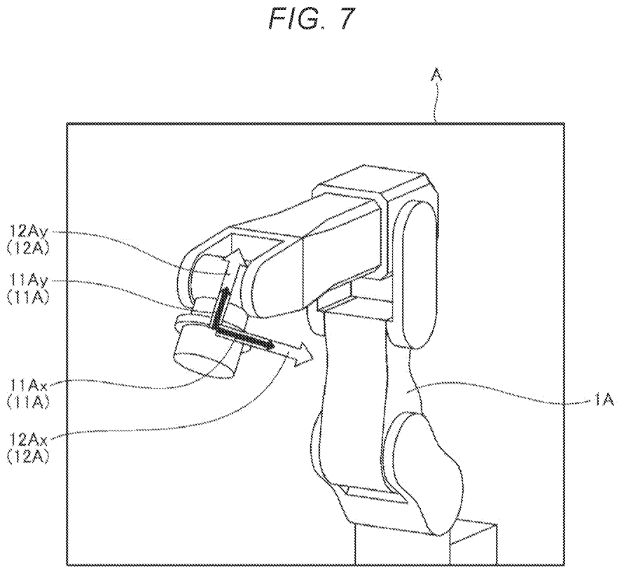

As shown in FIG. 7, the first indicator 11A and the second indicator 12A each may be resolved and displayed. In a configuration shown in FIG. 7, the target force f_{St} and force applied to the robot arm 10 each are resolved into components of the X axis and the Y axis in the distal end coordinate system and displayed. That is, an arrow indicating the X-axis component of the target force f_{St} is a first indicator 11Ax and an arrow indicating the Y-axis component of the target force f_{St} is a first indicator 11Ay. An arrow indicating the X-axis component of the force applied to the robot arm 10 is a second indicator 12Ax and an arrow indicating the Y-axis component of the force applied to the robot arm 10 is a second indicator 12Ay.

It is preferable that at least one of lengths, colors, and shapes of the second indicator 12Ax and the second indicator 12Ay change according to the magnitude of the force.

With such a configuration, the operator can grasp, at a glance, force along which axial direction is large.

In the configuration shown in FIG. 7, an arrow indicating a Z-axis component of the target force f_{St} is omitted. However, the arrow indicating the Z-axis component of the target force f_{St} may be displayed. In the configuration shown in FIG. 7, an arrow indicating a Z-axis component of the force applied to the robot arm 10 is omitted. However, the arrow indicating the Z-axis component of the force applied to the robot arm 10 may be displayed.

One or two or more of the X-axis component, the Y-axis component, and the Z-axis component of the target force f_{St} may be selected and displayed. One or two or more of the X-axis component, the Y-axis component, and the Z-axis component of the force applied to the robot arm 10 may be selected and displayed.

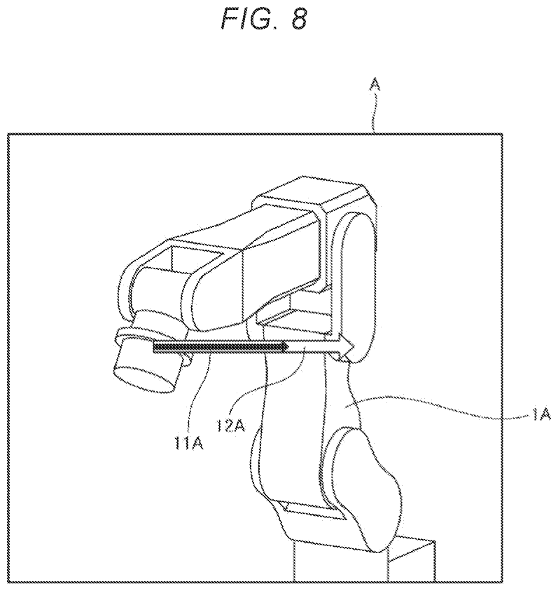

As shown in FIG. 8, the axis components of the target force f_{St} may be combined and displayed and the axis components of the force applied to the robot arm 10 may be combined and displayed. In this case, one of arrows pointing a direction of the combined axis components is the first indicator 11A and the other is the second indicator 12A. In a configuration shown in FIG. 8, the first indicator 11A and the second indicator 12A are displayed to overlap each other.

With such a configuration, the operator can grasp, at a glance, a degree of combined force obtained by combining the axis components.

In the configurations shown in FIGS. 3 to 8, the lengths of the arrows are changed according to the magnitude of the target force f_{St} and the magnitude of the force applied to the robot arm 10. However, in the present disclosure, the arrows are not limited to this. For example, as shown in an upper part in FIG. 9, thicknesses of arrows may be changed. As shown in a middle part in FIG. 9, sharpness degrees of arrows may be changed. As shown in a lower part in FIG. 9, shapes of arrows may be changed.

In a configuration shown in FIG. 10, the second indicator 12A is displayed as a graph G1 indicating, over time, the force applied to the robot arm 10. The graph G1 is displayed on the left side of a simulation image in which the virtual robot 1A and the first indicator 11A are displayed. In the graph G1, the vertical axis indicates the force applied to the robot arm 10 and the horizontal axis indicates time.

With such a configuration, the operator can grasp, over time, the force applied to the robot arm 10. In the graph G1, the set target force f_{St} is displayed. It is easy to compare the target force f_{St} with the force applied to the robot arm 10.

For example, when a cursor is placed in any position of the horizontal axis of the graph, the simulation image may be able to be reproduced from a time of the position and a part of the graph may flash or a color of the part may change such that force applied to the robot arm 10 at the time is clearly seen in the graph. Further, the virtual robot 1A may change a posture to indicate a posture of the robot arm 10 at the time on which the cursor is placed.

In a configuration shown in FIG. 11, the second indicator 12A is displayed as a graph G2 showing a component in the X-axis direction and a component in the Y-axis direction of the force applied to the robot arm 10. The graph G2 is displayed on the left side of a simulation image in which the virtual robot 1A and the first indicator 11A are displayed. In the graph G2, the vertical axis indicates a component in the Y-axis direction of the force applied to the robot arm 10 and the horizontal axis indicates a component in the X-axis direction of the force applied to the robot arm 10.

With such a configuration, the operator can grasp, for each of the components in the axial directions, the force applied to the robot arm 10.

As explained above, the robot system 100 according to the present disclosure includes the robot 1 including the robot arm 10 that performs work according to force control, the display section 40 that displays the display image A including the virtual robot 1A, which is the simulation model of the robot 1, and the control section 41 that controls the display section 40. The control section receives the information concerning the force control parameters including the first information concerning the target force f_{St}, which is the target of the force received by the robot arm 10 during work, and controls the operation of the display section 40 to display, in the display image A, the virtual robot 1A, the first indicator 11A indicating the first information, the second indicator 12A indicating the second information concerning the force applied to the robot arm 10 during the work, the virtual robot 1A, the first indicator 11A, and the second indicator 12A temporally overlapping one another and being distinguished from one another. Consequently, the operator can compare the target force f_{St} and the force applied to the robot arm 10 in a work result and easily determine whether setting of the force control parameters is proper. Accordingly, the operator can feedback the quality of the last setting and set appropriate force control parameters at the next and subsequently setting times.

As explained above, at least one of the colors, the sizes, and the shapes of the first indicator 11A and the second indicator 12A are different from each other. Consequently, the operator can distinguish, at a glance, the difference between the first indicator 11A and the second indicator 12A. All of the colors, the sizes, and the shapes of the first indicator 11A and the second indicator 12A may be different or two of the colors, the size, and the shapes may be different.

As explained above, the first indicator 11A is the arrow indicating the direction and the magnitude of the target force f_{St} and the second indicator 12A is an arrow indicating the direction and the magnitude of the force received by the robot arm 10. Since the first indicator 11A and the second indicator 12A are arrows, the operator can recognize the directions at a glance and, if at least one of colors, sizes, and shapes of the arrows are different from each other, the operator can distinguish the first indicator 11A and the second indicator 12A. As a result, the first indicator 11A and the second indicator 12A are easily seen in simple display.

In the configurations shown in the figures, the first indicator 11A and the second indicator 12A are the arrows. However, in the present disclosure, the first indicator 11A and the second indicator 12A are not limited to this and may be other indicators such as triangles, pentagons, and indicator lamps.

A display control method according to the present disclosure is explained with reference to a flowchart of FIG. 12. In the following explanation, the control section executes steps S101, S103, and S104 and the control device 3 executes step S102. However, in the present disclosure, the execution of the steps is not limited to this.

First, in step S101, the control section 41 receives information concerning force control parameters. That is, the operator sets force control parameters using the teaching device 4. The control section 41 stores the information in the storing section 42. Examples of items of the force control parameters set in this step include the mass coefficient m, the coefficient of viscosity d, the modulus of elasticity k, and the target force f_{St} serving as the first information.

Such a step S101 is a receiving step for receiving the information concerning the force control parameters including the first information concerning the target force f_{St}, which is the target of the force that the robot arm 10 receives during work.

Subsequently, in step S102, the control device 3 executes work. That is, the control device 3 executes work based on the information received in step S101.

Subsequently, in step S103, the control section 41 generates the display image A and displays on the display section 40. That is, the control section 41 acquires operation information for the work in step S102, generates the display image A shown in FIGS. 3 to 8, 10, and 11 based on the operation information, and displays the display image A on the display section 40.

Subsequently, in step S104, the control section determines whether the work is completed. This determination is made based on, for example, whether the number of times assembly work is performed has reached a predetermined number of times. When determining in step S104 that the work is completed, the control section 41 ends all programs. On the other hand, when determining in step S104 that the work is not completed, the control section 41 returns to step S102 and repeats the subsequent steps.

In this way, the display control method according to the present disclosure is a display control method for controlling a display section that displays the display image A including the virtual robot 1A, which is a simulation model of the robot 1 including the robot arm 10 that performs work according to force control, the display control method including a receiving step for receiving information concerning force control parameters including first information concerning the target force f_{St}, which is a target of force received by the robot arm 10 during the work, and a display step for displaying, in the display image A, the virtual robot 1A, the first indicator 11A indicating the first information, and the second indicator 12A indicating second information concerning force applied to the robot arm 10 during the work, the virtual robot 1A, the first indicator 11A, and the second indicator 12A temporally overlapping one another and being distinguished from one another. Consequently, the operator can compare the target force f_{St} and the force applied to the robot arm 10 in a work result and easily determine whether setting of the force control parameters is proper. Accordingly, the operator can feedback the quality of the last setting and set appropriate force control parameters at the next and subsequent setting times.

As explained above, in the display step, at least one of a color, a size, and a shape of an arrow, which is the second indicator 12A, is changed according to the force received by the robot arm 10 during the work. Consequently, the operator can grasp, over time, a change in the force received by the robot arm 10 during the work. In the display step, all of the color, the size, and the shape of the arrow, which is the second indicator 12A, may be changed or two of the color, the size, and the shape may be changed according to the force received by the robot arm 10 during the work.

As explained above, in the display step, at least one of a length, a thickness, and a sharpness degree of the arrow, which is the second indicator 12A, is changed according to the force received by the robot arm 10 during the work (see FIG. 9). Consequently, the operator can more clearly grasp a change in the force received by the robot arm 10 during the work. In the display step, all of the length, the thickness, and the sharpness degree of the second indicator 12A may be changed or two of the length, the thickness, and the sharpness degree may be changed according to the force received by the robot arm 10 during the work.

As explained above, in the display step, a posture of the virtual robot 1A is changed according to a change in a posture of the robot arm 10 during the work. Consequently, the operator can grasp, at a glance, which degree of force is applied in what kind of a posture the robot arm 10 has.

As explained above, in the display step, the first indicator 11A and the second indicator 12A are respectively resolved into components in the axial directions of the coordinate system set in the virtual robot 1A and displayed (see FIG. 7). Consequently, the operator can grasp, at a glance, force along which axial direction is large.

A display program according to the present disclosure is a program for executing a display control method for controlling a display section that displays a display image including the virtual robot 1A, which is a simulation model of the robot 1 including the robot arm 10 that performs work according to force control, the program causing a computer to execute a receiving step for receiving information concerning force control parameters including first information concerning the target force f_{St}, which is a target of force received by the robot arm 10 during the work and a display step for displaying, in the display image A, the virtual robot 1A, the first indicator 11A indicating the first information, and the second indicator 12A indicating second information concerning force applied to the robot arm 10 during the work, the virtual robot 1A, the first indicator 11A, and the second indicator 12A temporally overlapping one another and being distinguished from one another. By executing such a program, the operator can compare the target force f_{St} and the force applied to the robot arm 10 in a work result and easily determine whether setting of the force control parameters is proper. Accordingly, the operator can feedback the quality of the last setting and set appropriate force control parameters at the next and subsequent setting times.

The display program according to the present disclosure may be stored in a storing section of the control device 3 or the teaching device 4, may be stored in a recording medium such as a CD-ROM, or may be stored in a storage device connectable via a network or the like.

### Other Configuration Examples of a Robot System

FIG. 13 is a block diagram for explaining a robot system centering on hardware.

FIG. 13 shows an overall configuration of a robot system 100A in which the robot 1, a controller 61, and a computer 62 are coupled. Control of the robot 1 may be executed by reading out a command present in a memory with a processor present in the controller 61 or may be executed via the controller 61 by reading out the command present in the memory with a processor present in the computer 62.

Therefore, one or both of the controller 61 and the computer 62 can be grasped as a “control device”.

### Modification 1

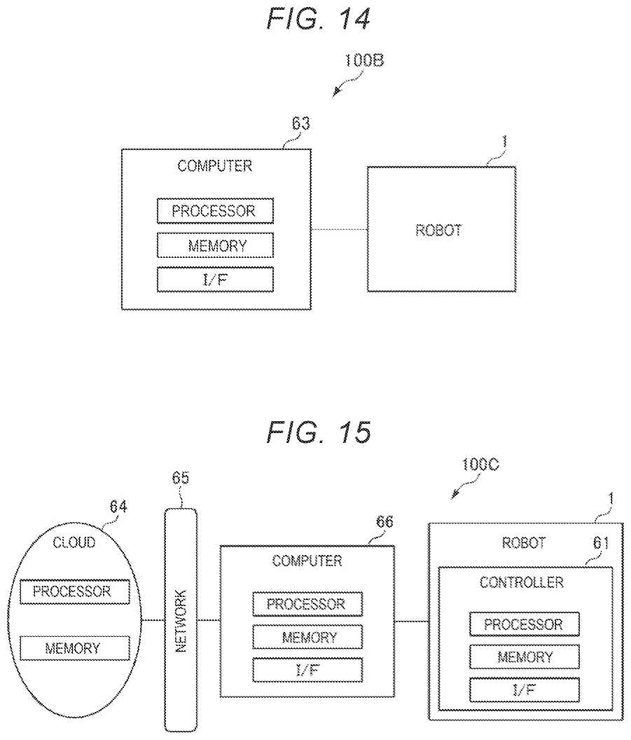

FIG. 14 is a block diagram showing a modification 1 centering on hardware of a robot system.

FIG. 14 shows an overall configuration of a robot system 100B in which a computer 63 is directly coupled to the robot 1. Control of the robot 1 is directly executed by reading out a command present in a memory with a processor present in the computer 63.

Therefore, the computer 63 can be grasped as a “control device”.

### Modification 2

FIG. 15 is a block diagram showing a modification 2 centering on hardware of a robot system.

FIG. 15 shows an overall configuration of a robot system 100C in which the robot 1 incorporating the controller 61 and a computer 66 are coupled and the computer 66 is coupled to Cloud 64 via a network 65 such as a LAN. Control of the robot 1 may be executed by reading out a command present in a memory with a processor present in the computer 66 or may be executed by reading out a command present in the memory via the computer 66 with a processor present on the Cloud 64.

Therefore, at least one, any two, or three of the controller 61, the computer 66, and the Cloud 64 can be grasped as a “control device”.

The display control method, the display program, and the robot system according to the present disclosure are explained above with reference to the embodiment shown in the figures. However, the present disclosure is not limited to this. The sections configuring the robot system can be replaced with sections having any configurations that can exert the same functions. Any components may be added.

What is claimed is:

1. A display control method for controlling a display section configured to display a display image including a virtual robot, which is a simulation model of a robot including a robot arm that performs work according to force control, the display control method comprising:
a receiving step for receiving information concerning force control parameters including first information concerning a target force, which is a target of force received by the robot arm during the work; and
a display step for displaying, in the display image, the virtual robot, a first indicator indicating the first information, and a second indicator indicating second information concerning force applied to the robot arm during the work, the virtual robot, the first indicator, and the second indicator temporally overlapping one another and being distinguished from one another.

2. The display control method according to claim 1, wherein at least one of colors, sizes, and shapes of the first indicator and the second indicator are different from each other.

3. The display control method according to claim 1, wherein
the first indicator is an arrow indicating a direction and magnitude of the target force, and
the second indicator is an arrow indicating a direction and magnitude of the force received by the robot arm.

4. The display control method according to claim 3, wherein, in the display step, at least one of a color, a size, and a shape of the arrow, which is the second indicator, is changed according to the force received by the robot arm during the work.

5. The display control method according to claim 4, wherein, in the display step, at least one of a length, a thickness, and a sharpness degree of the arrow, which is the second indicator, is changed according to the force received by the robot arm during the work.

6. The display control method according to claim 1, wherein, in the display step, a posture of the virtual robot is changed according to a change in a posture of the robot arm during the work.

7. The display control method according to claim 1, wherein, in the display step, the first indicator and the second indicator each are resolved into components in axial directions of a coordinate system set in the virtual robot and displayed.

8. A non-transitory computer-readable storage medium storing a display program for executing a display control method for controlling a display section configured to display a display image including a virtual robot, which is a simulation model of a robot including a robot arm that performs work according to force control, the display program causing a computer to execute:
a receiving step for receiving information concerning force control parameters including first information concerning a target force, which is a target of force received by the robot arm during the work; and
a display step for displaying, in the display image, the virtual robot, a first indicator indicating the first information, and a second indicator indicating second information concerning force applied to the robot arm during the work, the virtual robot, the first indicator, and the second indicator temporally overlapping one another and being distinguished from one another.

9. A robot system comprising:
a robot including a robot arm that performs work according to force control;
a display section configured to display a display image including a virtual robot, which is a simulation model of the robot; and
a control section configured to control the display section, wherein
the control section receives information concerning force control parameters including first information concerning a target force, which is a target of force received by the robot arm during the work and displays, in the display image, the virtual robot, a first indicator indicating the first information, and a second indicator indicating second information concerning force applied to the robot arm during the work, the virtual robot, the first indicator, and the second indicator temporally overlapping one another and being distinguished from one another.
